(19) United States
(12) Patent Application Publication
(10) Pub. No.: US 2013/0185987 A1
(43) Pub. Date: Jul. 25, 2013

(54) GLOW STICK FISHING LURE

(71) Applicant: Gregory Peter Downs, Little Egg Harbor, NJ (US)

(72) Inventor: Gregory Peter Downs, Little Egg Harbor, NJ (US)

(21) Appl. No.: 13/612,825

(22) Filed: Sep. 12, 2012

Related U.S. Application Data
(60) Provisional application No. 61/590,145, filed on Jan. 24, 2012.

(51) Int. Cl. A01K 85/01

(52) U.S. Cl. 43/17.6

(57) ABSTRACT

A fishing lure accepts a glow stick inserted therein to provide night illumination. The fishing lure uses interchangeable glow sticks which are inexpensive and can be changed as needed for illumination. The fishing lure allows for the easy and quick insertion and removal of a glow stick as needed and saves the user a lot of time and is very cost effective. The fishing lure can be designed in various configurations, such as a plug-type lure with the glow stick inserted fully or with the glow stick protruding out of the lure. In some embodiments, a squid-type lure can be designed with one or more glow sticks used to provide illumination.

### CROSS-REFERENCE TO RELATED APPLICATION

This application claims the benefit of priority of U.S. provisional application No. 61/590,145, filed Jan. 24, 2012, the contents of which are herein incorporated by reference.

### BACKGROUND OF THE INVENTION

The present invention relates to fishing lures and, more particularly, to a fishing lure that accepts a glow stick inserted into it to provide night illumination to the fishing lure.

Glow in the dark fishing lures conventionally require the user to put the lure under an artificial light to make it glow or use a glow paint which has to be applied again after it fades. Some glow sticks include a permanent chemical in it that makes it glow for up to 10 years, but these cannot be changed or removed from the fishing lure. Therefore, the user has to buy another lure to get this type of glowing lure in a different design.

As can be seen, there is a need for a fishing lure that can provide illumination without having to take extra steps of charging the glow in the dark material or reapplying glow paint and allows an easy way to have multiple lure designs that can illuminate.

### SUMMARY OF THE INVENTION

In one aspect of the present invention, a fishing lure comprises a main body; a leader line passing through the main body; a hook on an end of the leader line; and at least one glow stick at least partially insertable into the main body.

In another aspect of the present invention, a fishing lure comprises a main body; a leader line into one end of the main body and extending out a side portion of the main body; a hook on an end of the leader line; and at least one glow stick at least partially insertable into the main body.

In a further aspect of the present invention, a fishing lure comprises a lure head; a leader line passing through a central region of the lure head; a hook disposed on an end of the leader line; a plurality of tentacle lines extending from about an outer periphery of the lure head; a glow stick sleeve disposed on ends of each of the plurality of tentacle lines; and a glow stick sleeve disposed in a central portion of the lure head.

These and other features, aspects and advantages of the present invention will become better understood with reference to the following drawings, description and claims.

### BRIEF DESCRIPTION OF THE DRAWINGS

FIG. 1 is a perspective view of an illuminated lure, in use, according to an exemplary embodiment of the present invention;

FIG. 2 is a perspective view of the illuminated lure of FIG. 1;

FIG. 3 is a cross-sectional view taken along line 3-3 of FIG. 2;

FIG. 4 is a perspective view of an illuminated lure, in use, according to another exemplary embodiment of the present invention;

FIG. 5 is a perspective view of the illuminated lure of FIG. 4;

FIG. 6 is a cross-sectional view taken along line 6-6 of FIG. 5;

FIG. 7 is a perspective view of an illuminated squid-type lure, in use, according to another exemplary embodiment of the present invention;

FIG. 8 is a perspective view of the illuminated squid-type lure of FIG. 7; and

FIG. 9 is a cross-sectional view taken along line 9-9 of FIG. 8.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fishing lure that accepts a glow stick inserted therein to provide night illumination. The fishing lure uses interchangeable glow sticks which are inexpensive and can be changed as needed for illumination. The fishing lure allows for the easy and quick insertion and removal of a glow stick as needed and saves the user a lot of time and is very cost effective. The fishing lure can be designed in various configurations, such as a plug-type lure with the glow stick inserted fully or with the glow stick protruding out of the lure. In some embodiments, a squid-type lure can be designed with one or more glow sticks used to provide illumination.

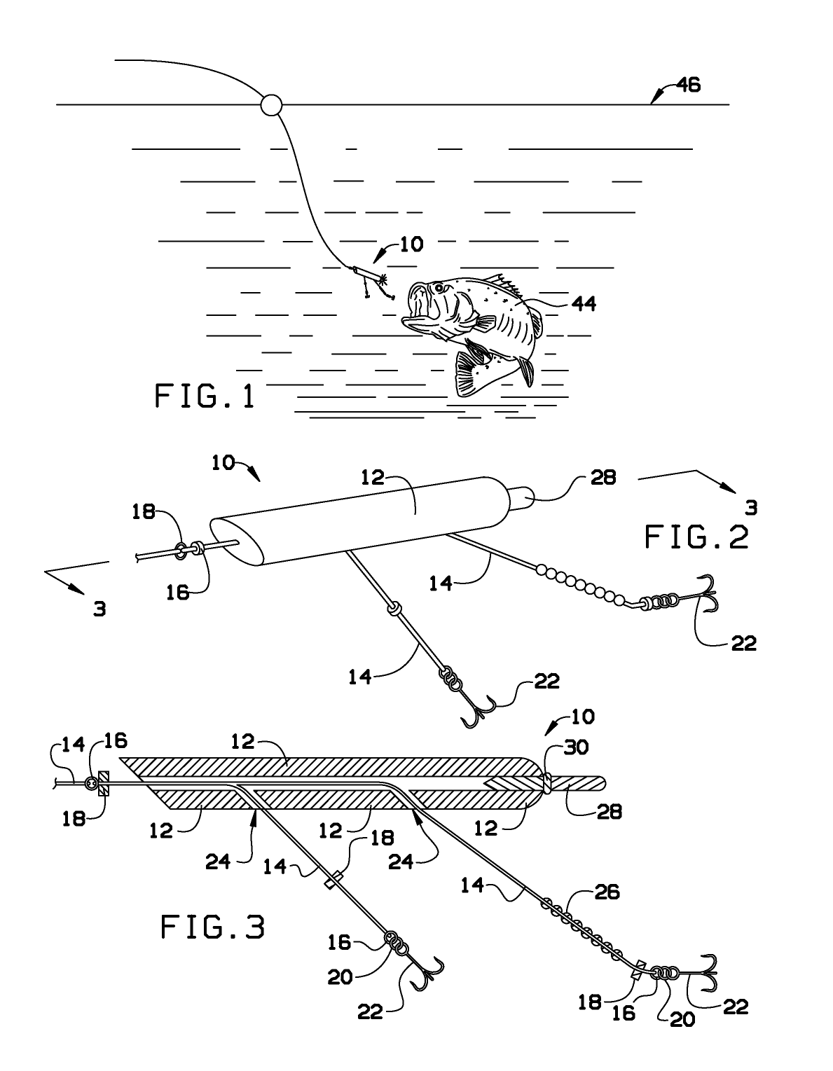

Referring to FIGS. 1 through 3, a lure 10 can include a clear or colored main body 12. The main body 12 can be made from various materials, such as plastic, resin, epoxy, composite or the like. A leader line 14 can pass into the main body 12 and one or more leader lines 14 can exit from the main body 12 through holes 24 formed therein, each exiting leader line 14 having a hook 22 on the end. Typically, two leader lines 14 with hooks 22 extend from the main body 12. While treble hooks are shown in the Figures, various types, sizes and hook materials can be used in the present invention.

Loops can be disposed on the leader line 14 and leader sleeves 18 can be used to control the movement of the leader line 14 through the main body 12. A swivel or split ring 20 can be used to connect the hook 22 to the ends of the leader line(s) 14. In some embodiments, optional decorative colored beads 26 can be disposed along the leader line.

A glow stick 28 can be inserted into the main body 12. An expansion plug 30 at the end of the main body 12 can secure the glow stick 28 in the lure 10. Typically, the glow stick 28 can be inserted such that a portion of the glow stick 28 is inside the lure 10, causing the lure 10 to glow when the lure 10 is made of a translucent material, and a portion of the glow stick 28 can extend from the end of the lure 28, causing a brighter, direct glow at the tail end of the lure 10. The lure 10, as well as the lures 48, 50 described below, can successfully attract fish 44 when fishing in a body of water 46.

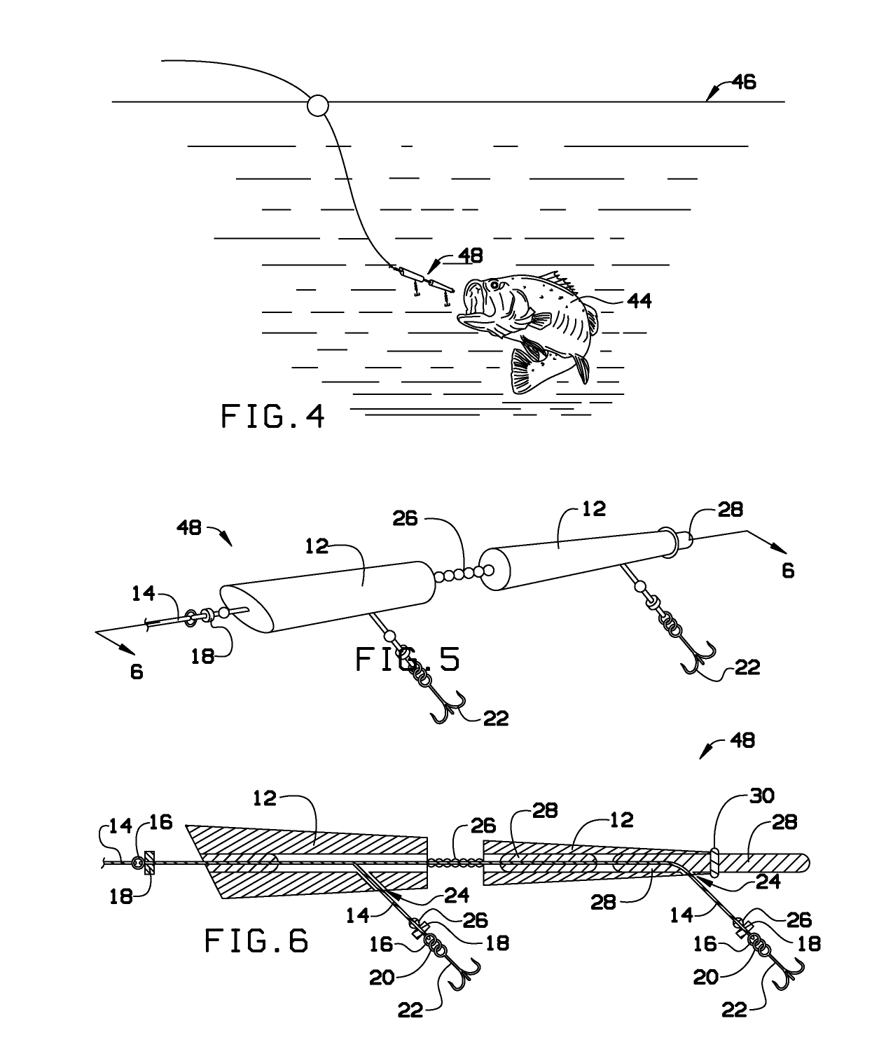

Referring now to FIGS. 4 through 6, the jointed fishing lure 48 can include two main bodies 12 with the leader line 14 passing through the both main bodies 12 with one or more hooks extending out of each of the main bodies 12. Typically one hook 22 extend, via leader lines 14, out of each of the two main bodies 12. The two main bodies can be connected by the leader line, typically with decorative beads disposed therealong. This configuration allows the second main body 12 to pivot relative to the first, creating a fish tail-like movement.

Glow sticks 28 can be inserted into completely into the main body of the second main body 12, causing it to glow. A second glow stick 28 can be inserted into the back of the second main body 12, protruding therefrom and secured with the expansion plug 30. This second glow stick 28 can create an attractive lighting effect in the water as the second main body moves about in the water.

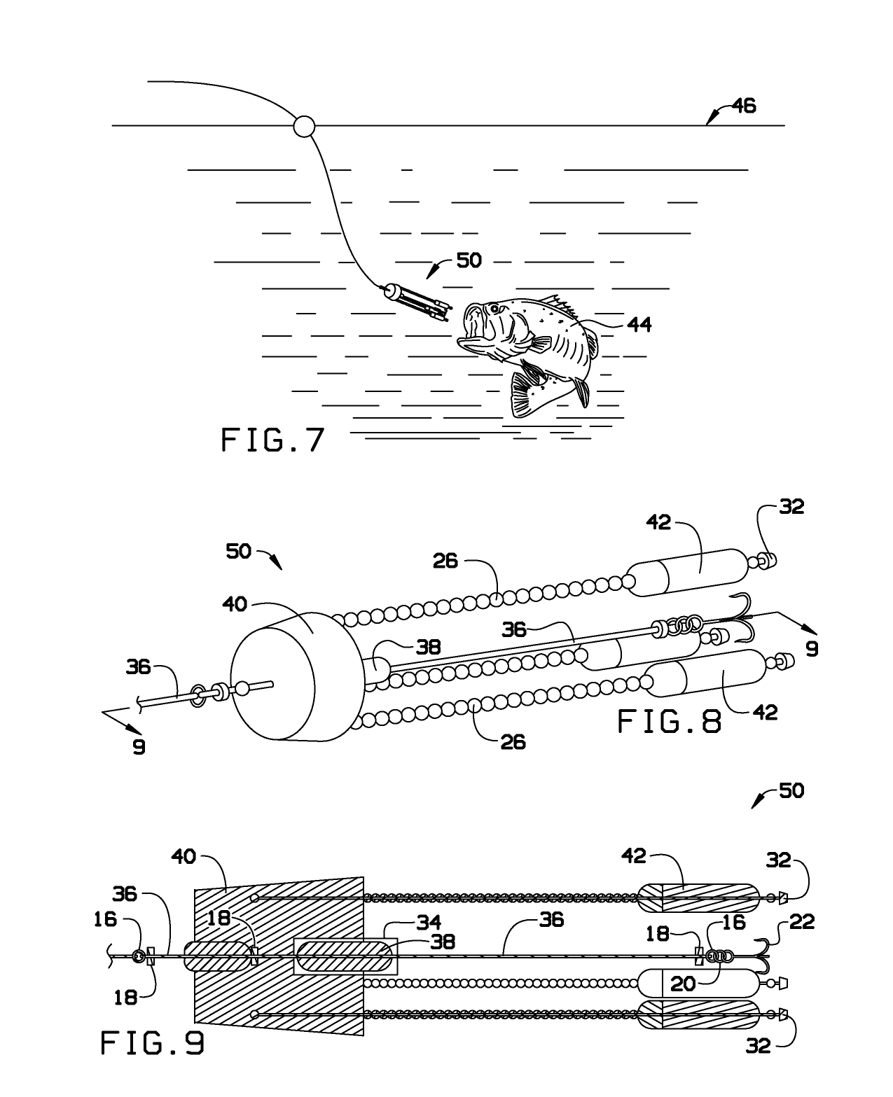

Referring to FIGS. 7 through 9, a squid-type fishing lure 50 can be designed to use glow sticks 28 for attracting fish. A monofilament leader 36 can pass through a central region of a lure head 40, typically made of a clear or translucent material, such as epoxy. The leader 36 can extend through the lure head 40 and out the other side, having a hook 22 attached on an end thereof, typically in a manner similar to that above, using a leader sleeve 18, split ring 20, and loop 16, for example.

A plurality of additional lines can be formed in the lure head 40 and extend therefrom. Typically, about three such lines can extend from the lure head 40, equally spaced apart and near an outer periphery thereof. These lines can include beads 26 disposed therealong. A glow stick sleeve 42 can be disposed on the ends of each of these lines, with a crimped leader sleeve 32 retaining the sleeve 42 on the end of the line. The glow stick sleeve 42 can hold a glow stick therein.

The lure head 40 can include a plastic leader sleeve 34 formed therein. This sleeve 34 can accept a glow stick 38 therein, causing the lure head to be illuminated. Typically, the sleeve 34 can extend from the underside of the lure head, as shown in FIGS. 8 and 9.

The squid-type lure 50 can be used with one or more glow sticks 38. In some embodiments, the lure 50 can be used with only the glow sticks in the lure head, or with the glow sticks on the tentacles, or with all four glow sticks in place, depending on the user's experience and desired effect.

The lures 10, 48, 50 can be made by various methods. For example, a mold could be used to accept a two-part epoxy and a straw tube, or the like, can be used to form central passages through the lure main bodies. Of course, other methods can be used to make the lures, including plastic injection molding or the like. Typically the lure can be made from an environmentally safe resin and allows the line to pass through for easy replacement.

It should be understood, of course, that the foregoing relates to exemplary embodiments of the invention and that modifications may be made without departing from the spirit and scope of the invention as set forth in the following claims.

What is claimed is:

1. A fishing lure comprising:
a main body;
a leader line passing through the main body;
a hook on an end of the leader line; and
at least one glow stick at least partially insertable into the main body.

2. The fishing lure of claim 1, further comprising two leader lines extending out of the main body, each having the hook on the end thereof.

3. The fishing lure of claim 1, wherein the main body includes a first section and a second section, the first and second sections connected by the leader line, where the first section pivots relative to the second section.

4. The fishing lure of claim 3, wherein the second section includes a first glow stick protruding out the end thereof.

5. The fishing lure of claim 4, wherein the second section includes a second glow stick disposed inside the second section.

6. The fishing lure of claim 1, further comprising a plurality of lines extending from a periphery of the main body, each of the plurality of lines having a glow stick sleeve disposed on an end thereof.

7. The fishing lure of claim 1, further comprising colored beads disposed along at least one portion of the leader line.

8. A fishing lure comprising
a main body;
a leader line into one end of the main body and extending out a side portion of the main body;
a hook on an end of the leader line; and
at least one glow stick at least partially insertable into the main body.

9. The fishing lure of claim 8, further comprising two leader lines extending out of the side portion the main body, each having the hook on the end thereof.

10. The fishing lure of claim 8, wherein the main body includes a first section and a second section, the first and second sections connected by the leader line, where the first section pivots relative to the second section.

11. A fishing lure comprising:
a lure head;
a leader line passing through a central region of the lure head;
a hook disposed on an end of the leader line;
a plurality of tentacle lines extending from about an outer periphery of the lure head;
a glow stick sleeve disposed on ends of each of the plurality of tentacle lines; and
a glow stick sleeve disposed in a central portion of the lure head.

12. The fishing lure of claim 11, further comprising colored beads disposed along the plurality of tentacle lines.

13. The fishing lure of claim 11, wherein the plurality of tentacle lines includes three tentacle lines.
